(19) United States
(12) Patent Application Publication
(10) Pub. No.: US 2013/0244843 A1
(43) Pub. Date: Sep. 19, 2013

(54) WEIGHT EXERCISE APPARATUS

(71) Applicants: Jerry J Burwell, Salisbury, NC (US); David Ingrum Kemble, Dallas, TX (US)

(72) Inventors: Jerry J Burwell, Salisbury, NC (US); David Ingrum Kemble, Dallas, TX (US)

(73) Assignee: ROCKETLOK, LLC, Dallas, TX (US)

(21) Appl. No.: 13/615,514

(22) Filed: Sep. 13, 2012

Related U.S. Application Data
(60) Provisional application No. 61/534,135, filed on Sep. 13, 2011.

(51) Int. Cl. A63B 21/075; B23P 19/00

(52) U.S. Cl. CPC A63B 21/075; B23P 19/00
USPC 482/108; 29/428

(57) ABSTRACT

According to the present invention, there is provided a weight apparatus, that includes a body. A first cavity is defined within the body such that it extends to an open end. A cap is configured to engage the body at the open end of the first cavity such that the first cavity is closed. A master latch configured to be retained by the cap. The cap is configured to rotate between an open first position and a closed second position. In the open first position, the cap can be separated from the body such that the first cavity is accessible and in the closed second position the cap cannot be separated from the body. The master latch is configured to secure the cap in the second position when the master latch is in a latched position. A safety latch is configured to secure the master latch in the latched position.

### FIELD OF THE INVENTION

The invention relates generally to a means for adjusting the weight of an exercise apparatus and specifically to a means of securing and removing weights from barbells, dumbbells, kettlebells, and similar exercise equipment.

### BACKGROUND OF THE INVENTION

It is often desirable for fitness equipment used for weight training, or resistance training, to be configured such that exercises can be done using the same basic equipment, but at different weights, or resistances. As a result, fitness exercises are commonly performed using an apparatus that can weigh one of a plurality of predetermined weights. Such apparatuses include barbells, dumbbells, kettlebells, and machines configured to provide various weights, i.e, resistances, against one or more different motions.

One problem with conventional adjustable weight apparatuses is that the position of the center of gravity can differ for different weights.

Another problem with conventional adjustable weight apparatuses is they they do not have surface features that are similar to non-adjustable versions. In other words, some conventional adjustable-weight kettlebells are not shaped like non-adjustable kettlebells. For example, non-adjustable kettlebells have gently-curved, smooth surfaces. They are often used for various exercises that require contact of the kettlebell against different parts of the body. For example, many exercises using kettlebells require palming of the exercise device. Conventional adjustable kettlebells are not shaped such that they are easily or effectively palmed for the purposes of exercise.

Another problem with conventional adjustable weight kettlebells is that they have a retaining pin or shaft that extends from the body of the weight and might interfere with use of the device.

Yet another problem with conventional adjustable-weight kettlebells is that some require a tool for adjustment of weight.

Yet another problem with conventional adjustable-weight kettlebells is that they are not durable enough to be safely dropped and reused. This is important because for many kettlebell exercises the exerciser will drop the kettlebell accidentally or if they become hurt or overly tired. Conventional adjustable weight kettlebells have retention features such as threaded closures or pins or shafts that could become damaged when dropped such that they bind.

### SUMMARY OF THE INVENTION

The present invention addresses the foregoing problems by providing a kettlebell having a body configured to receive one or more inserts that each have a predetermined weight. The inserts are dimensioned to be retained within the body by a cap configured to be attached to the body by an interlocking cam system.

According to one embodiment of the present invention, there is provided a weight apparatus, that includes a body that has a first cavity defined therein and the cavity extends from a closed end to an open end. A cap is configured to engage the body at the open end of the first cavity such that the first cavity is closed. A master latch that is configured to be retained by the cap. The cap is configured to rotate between an open first position and a closed second position. When in the open first position the cap can be separated from the body such that the first cavity is accessible and in the closed second position the cap cannot be separated from the body. The master latch is configured to move between an unlatched first position wherein the master latch does not interfere with rotation of the cap and a latched second position wherein the master latch does interfere with rotation of the cap.

According to one aspect of the present invention, the cap includes a safety latch that is configured to move between an off first position wherein the master latch is free to move between the unlatched position and the latched position and an on second position wherein the master latch is not free to move between the unlatched position and the latched position.

According to one aspect of the present invention, a first insert having a first predetermined weight is configured to be received within the first cavity and retained therein by the cap when the cap is in the closed second position.

According to one aspect of the present invention, the first insert is configured to receive a second insert having a second predetermined weight such that both weights are retained within the first cavity by the cap when the cap is in the closed position.

According to one aspect of the present invention, the weight apparatus has a center of gravity positioned at a first predetermined location when no inserts are positioned within the cavity.

According to one aspect of the present invention, the weight apparatus has a center of gravity positioned generally at the first predetermined location when a first insert is positioned within the cavity.

According to one aspect of the present invention, the weight apparatus has a center of gravity positioned generally at the first predetermined location when a second insert is positioned within the first insert.

According to another embodiment of the present invention, there is provided a body, a cavity defined in the body, a first insert, a second insert, a cap that is configured such that it can be engaged with the body in a manner sufficient to retain at least one of the first and second inserts within the cavity, a master latch that is movable between a latched position and an unlatched position and the master latch is configured to retain the cap such that it is engaged with the body when the master latch is in the latched position, and a safety latch that is configured to be movable between an off position and an on position such that when the safety latch is in the on position, the master latch is retained in the latched position.

According to one aspect of the present invention, the cap includes a plurality of tabs and the body includes a plurality of ears and the tabs and the ears are configured to interact such that the cap is retained over the cavity.

According to one aspect of the present invention, the master latch includes a tongue that is configured to engage with adjacent ears of the body when the master latch is in the latched position such that the cap cannot be rotated relative to the body.

According to one aspect of the present invention, the first insert is configured to receive the second insert therein such that both weights are retained within the cavity when the cap is engaged with the body.

According to one aspect of the present invention, the weight apparatus has a center of gravity positioned at a first predetermined location when no inserts are positioned within the cavity.

According to one aspect of the present invention, the weight apparatus has a center of gravity positioned generally at the first predetermined location when a first insert is positioned within the cavity.

According to one aspect of the present invention, the weight apparatus has a center of gravity positioned generally at the first predetermined location when a second insert is positioned within the first insert.

According to another embodiment of the present invention, there is provided a method for adjusting the weight of an exercise apparatus. The method includes the steps of: A) providing_a body, a cavity defined in the body, a first insert, a cap that is configured such that it can be engaged with the body in a manner sufficient to retain at least one of the first and second inserts within the cavity, a master latch that is movable between a latched position and an unlatched position and the master latch is configured to retain the cap such that it is engaged with the body when the master latch is in the latched position, and a safety latch that is configured to be movable between an off position and an on position such that when the safety latch is in the on position, the master latch is retained in the latched position, B) placing the first insert within the cavity, C) positioning the cap over the cavity, D) engaging the cap with the body, E) ensuring that the safety latch is in the off position and the master latch is in the unlatched first position, F) moving the master latch such that it is in the latched position, and G) moving the safety latch such that it is in the on position.

### BRIEF DESCRIPTION OF THE DRAWINGS

For a fuller understanding of the nature and objects of the present invention, reference should be made to the following detailed description taken in connection with the accompanying drawings, wherein:

FIG. 1 is a front view of a kettlebell according to the present invention wherein a master latch and a cap are positioned such that the cap can be removed from the body of the kettlebell;

FIG. 2 is a front view of the kettlebell in FIG. 1 wherein the master latch is positioned such that the cap cannot be rotated and the safety latch is positioned such that the master latch can be moved;

FIG. 3 is a front view of the kettlebell in FIG. 1 wherein the master latch is positioned such that the cap cannot be removed without first repositioning the master latch and the safety latch is in a latched position;

FIG. 4 is a sectional view of the kettlebell in FIG. 1 taken along line 4-4;

FIG. 5 is a sectional view of the kettlebell in FIG. 2 taken along line 5-5;

FIG. 6 is a front few of a kettlebell body and handle;

FIG. 7 is a sectional view of the kettlebell in FIG. 6 taken along line 7-7;

FIG. 8 is a partially enlarged perspective view showing a stop according to the present invention.

FIG. 9 is a front view of a cap according to the present invention;

FIG. 10 is a side view of the cap in FIG. 9.

FIG. 11 is a back view of the cap in FIG. 9;

FIG. 12 is a sectional view of the cap in FIG. 9 taken along line 12-12;

FIG. 13 is a perspective, partially-exploded view of a kettlebell according to the present invention;

FIGS. 14A and 14B are perspective views of a cap without a master latch or safety latch being in place according to one embodiment of the present invention; and

FIGS. 15A and 15B are perspective views of a master latch separate from the cap component shown in FIGS. 14A and 14B.

### DETAILED DESCRIPTION OF THE PREFERRED EMBODIMENTS

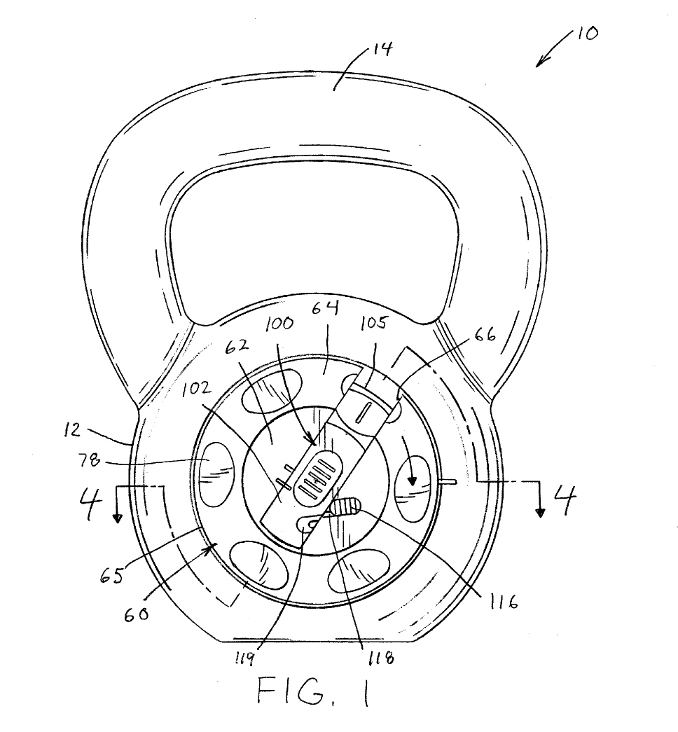

Embodiments of the present invention are directed to an improved system for the retention of weighted inserts within or on an exercise apparatus. Referring now to FIG. 1, there is shown a kettlebell 10. It should be appreciated that in other embodiments the present invention can be implemented in various types of exercise apparatuses in addition to kettlebell 10. By way of example and not limitation, such exercise apparatuses can include the following: dumbbells, barbells, weight lifting machines, medicine balls. According to the present invention, kettlebell 10 is adjustable to different weights or resistances while generally maintaining a predetermined center of gravity.

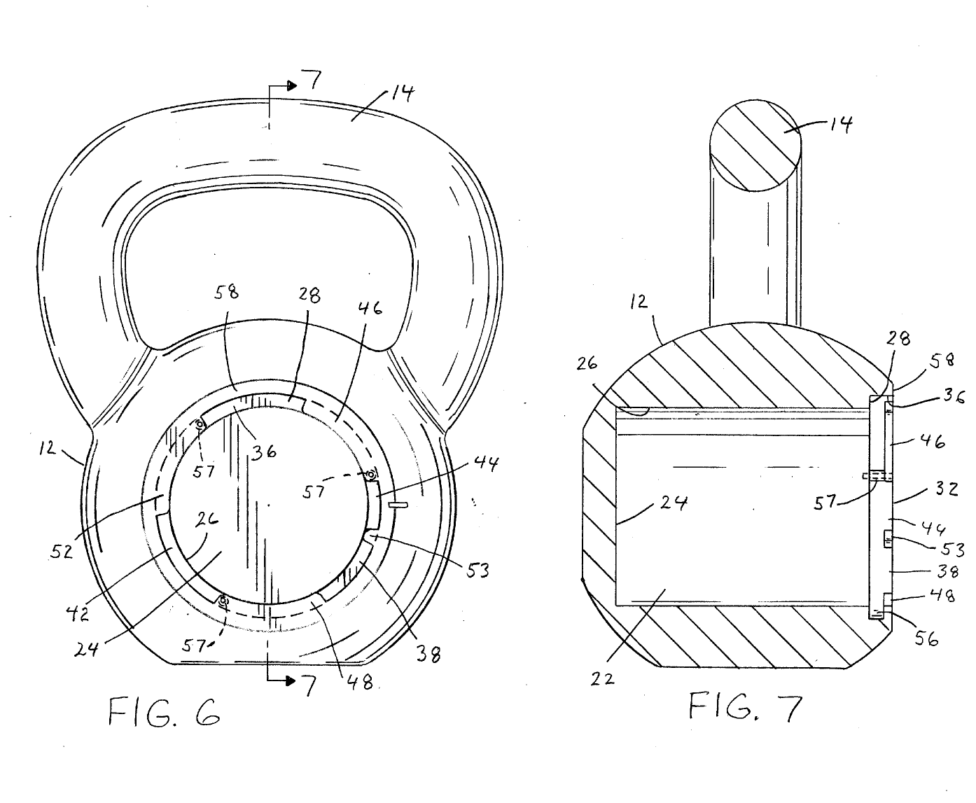

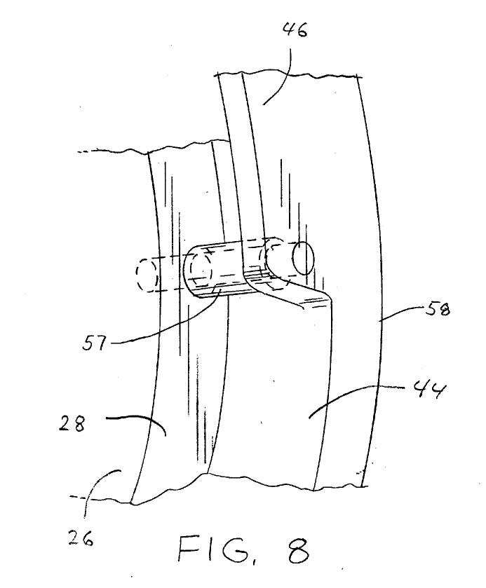

Referring to FIGS. 1 and 7, in accordance with an embodiment of the invention, kettlebell 10 includes a body 12, a handle 14, and a cap 60. As shown in FIG. 7, body 12 includes a first cavity 22 formed therein. First cavity 22 is defined by a side wall 26 of body 12 and first cavity 22 extends from an end wall 24 to an open end 32. In the illustrated embodiment, first cavity 22 is generally cylindrical such that it has a generally circular cross-section. In other embodiments, first cavity 22 can have a non-circular cross-section. By way of example and not limitation, such non-circular cross-sections can be octagonal, hexagonal, square, and other regular or irregular geometries. Side wall 26 defines a shoulder 28 at open end 32.

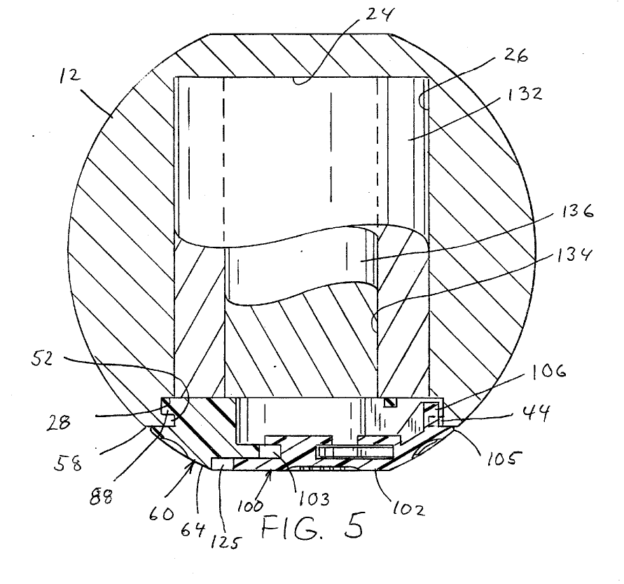

As shown in FIG. 6, a plurality of ears is spaced radially around open end 32 of cavity 22. In the illustrated embodiment, the plurality of ears includes a first ear 46, a second ear 48, a third ear 52 and a fourth ear 53 that are each spaced-apart from shoulder 28 to define a locking track 56. A pin 57 extends from each of first ear 46, second ear 48, and third ear 52 such that passage of the ears along locking track 56 is limited by contact of at least one pin 57 with an adjacent ear 46, 48, 52. The ears and body 12 also define a generally circular face 58 that is positioned around the open end 32 of cavity 22. A stopping pin The plurality of ears defines a plurality of recesses that are positioned between the ears. The plurality of recesses include a first recess 36 positioned between first ear 46 and third ear 52, a second recess 38 positioned between second ear 48 and fourth ear 53, and a third recess 42 positioned between second ear 48 and third ear 52. A safety latch recess 44 is positioned between first ear 46 and fourth ear 53.

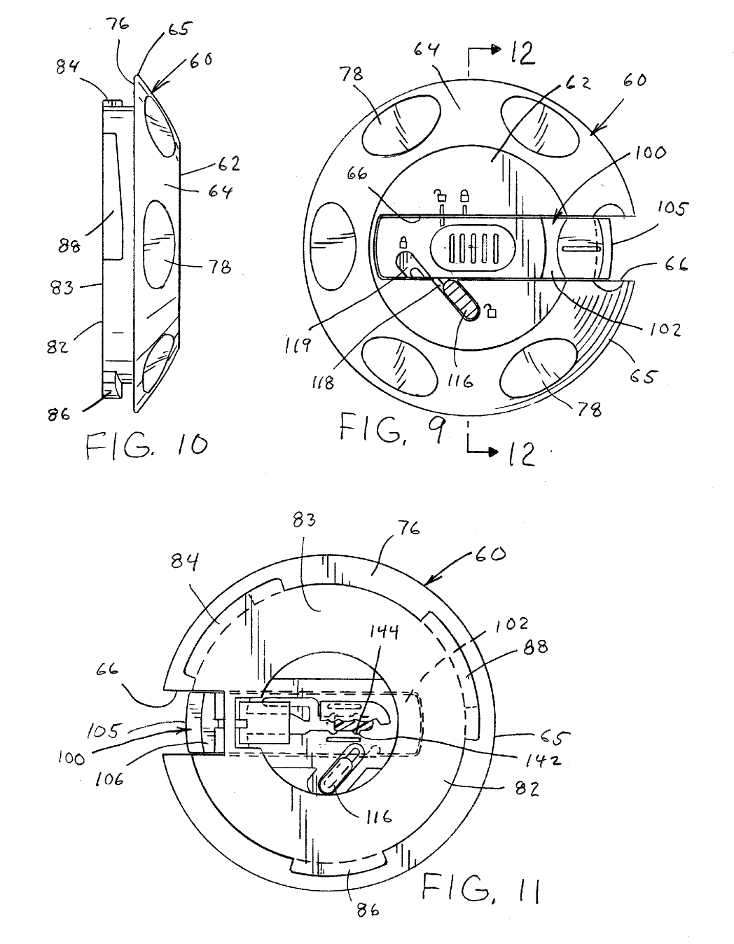

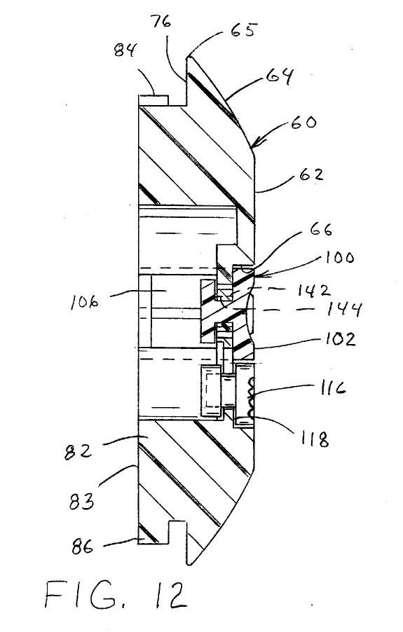

Referring now to FIGS. 1, 4, 7, and 9; body 12 is configured to receive cap 60 such that is it positioned against circular face 58 and is configured to seal first cavity 22. Cap 60 is configured to be rotated between an open unsecure first position and a closed and secure second position. As shown in FIG. 9, cap 60 includes a top 62 and a sloped shoulder 64 that extends from top 62 to a rim 65. Sloped shoulder 64 also defines a flange face 76, as shown in FIG. 10. Continuing to refer to FIG. 9, a plurality of dimples 78 are positioned in sloped shoulder 64 and are configured to provide a surface for gripping when cap 60 is removed from body 12. In other embodiments, sloped shoulder 64 includes other surface configurations. By way of example and not limitation, such other surface configurations include the following: smooth, knurled, pits or depressions, ridges, grooves, and a combination thereof.

Cap 60 also includes a base 82 that is positioned adjacent flange face 76 and extends away from the top surface 62 of cap 60 as shown in FIG. 10. The base is configured to be received within open end 32 as shown in FIG. 4. A plurality of spaced-apart tabs is positioned radially around the base and include a first tab 84, a second tab 86, and a third tab 88. Each of the plurality of tabs 84, 86, and 88 have a first side this is generally flush with a bottom surface 83 of base 82 and a sloped second side that is positioned away from the bottom surface 83 toward flange face 76.

The sloped second side of each tab has a camming face that is positioned opposite flange face 76. The camming face extends from a narrow end of the respective tab to a thicker end of the respective tab. The camming face is configured such that an ear of the opening of body 12 of kettlebell 10 is captured between a tab and flange face 76 when cap 60 is in the closed first position. In this regard, first ear 46 is configured to be captured between first tab 84 and flange face 76, second ear 48 is configured to be captured between second tab 86 and flange face 76, and third ear 52 is configured to be captured between third tab 88 and flange face 76.

When cap 60 is in the unsecure, open first position, first tab 84 is aligned with first recess 36, second tab 86 is aligned with second recess 38, and third tab 88 is aligned with third recess 42. When in the unsecure, open first position, cap 60 can be moved away from body 12 of kettlebell 10 such that first cavity 22 is open.

Referring now to FIGS. 1, 2, 4, 5, cap 60 is configured to receive a master latch 100 in a slot 66. Master latch 100 includes a sliding body 102, a latch shoulder 104, a tip 105, and a tongue 106. Master latch 100 is configured to move between a latched first position and an unlatched second position. FIGS. 1, 4, and 9 show master latch 100 in the first position wherein master latch 100 is positioned such that safety latch receiver 119 and safety track 118 are displaced relative to each other and tip 105 of master latch 100 is positioned away from, and out of line with, the rim 65. As can be seen in FIG. 4, when cap 60 is positioned within open end 32 of cavity 22 and master latch 100 is in the first position, a first void 124 is defined between tongue 106 and body 12 of kettlebell 10.

When master latch 100 is in its second position and cap 60 is positioned within the opening of body 12 of kettlebell 10, second void 125 is formed between master latch 100 and cap 60. In addition, tongue 106 is positioned within master latch recess 44 such that tongue 106 is between first ear 46 and flange face 76. Tongue 106, first ear 46, and fourth ear 53 are configured to prevent rotational movement of cap 60 relative to body 12 of kettlebell 10 when master latch 100 is in the second position and cap 60 is positioned in the opening. In this regard, if cap 60 were to be rotated relative to body 12, such movement would be blocked by the interaction of tongue 106 and first ear 46 or tongue 106 and fourth ear 53.

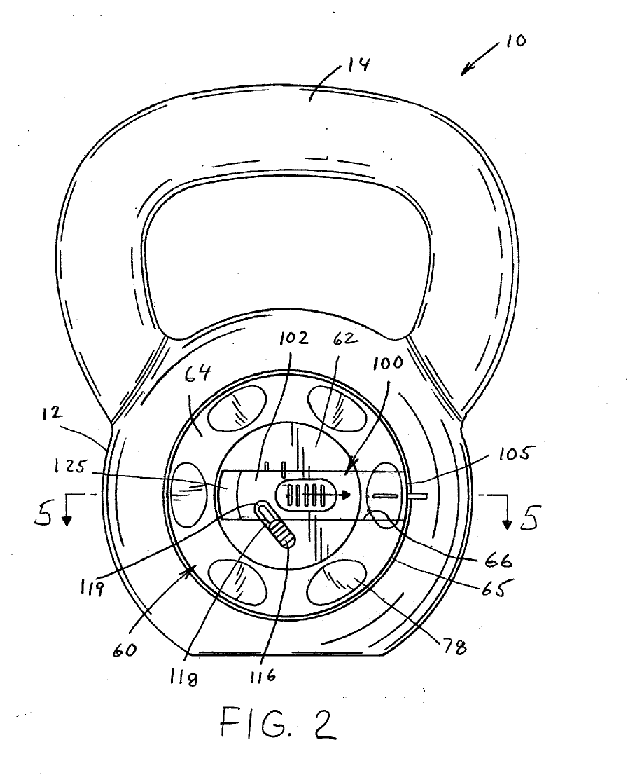

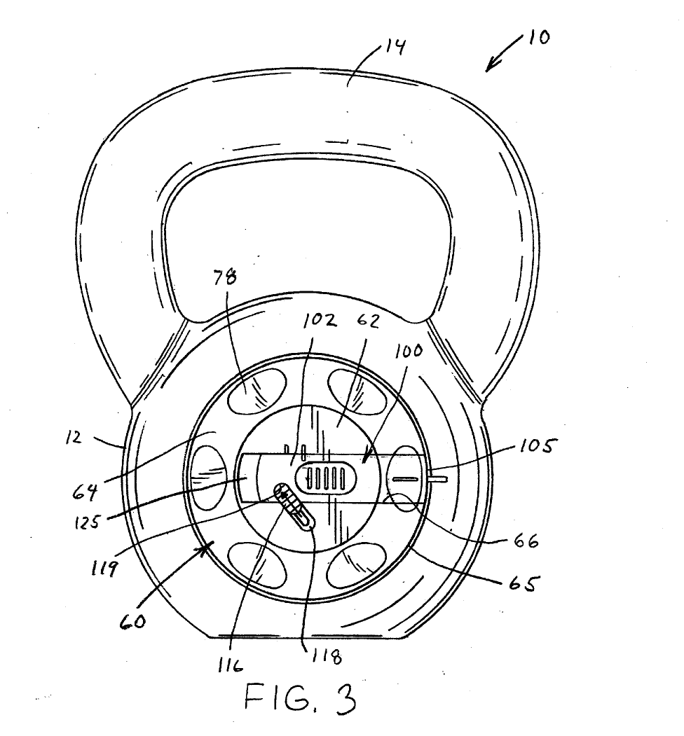

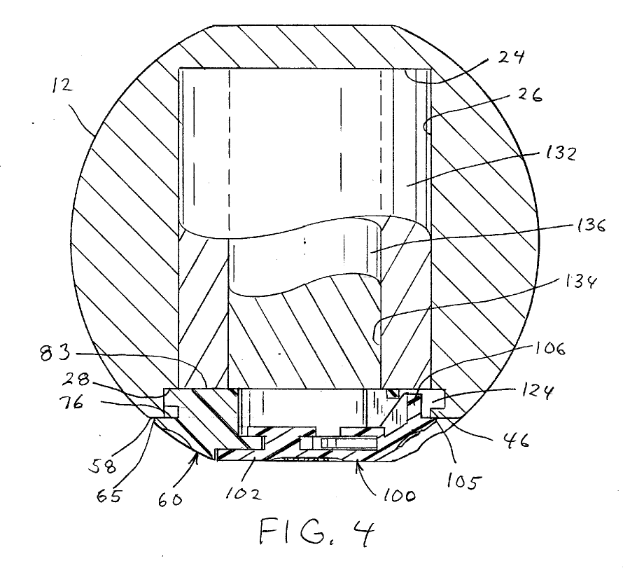

Sliding body 102 is configured to be received within a sliding body track 103. As shown in FIG. 1, a safety latch receiver 119 is defined in sliding body 102. Safety latch receiver 119 is a notch, recess, or opening dimensioned to receive a safety latch 116. Safety latch 116 is configured to be retained in a safety track 118 that is defined in the top of cap 60. Safety latch 116 is configured to move between an off first position in which safety latch 116 is clear of master latch 100 and an on second position in which a portion of safety latch 116 is received within safety latch receiver 119. When safety latch 116 is in its off, first position, safety latch 116 does not interfere with movement of master latch 100. When safety latch 116 is in its on second position, safety latch 116 is configured to prevent movement of master latch 100. In this regard, when safety latch 116 in its second position, master latch 100 cannot be moved between its first position and its second position. FIGS. 2 and 5 show master latch 100 in it's latched second position wherein master latch 100 is positioned such that safety latch receiver 119 and safety track 118 are aligned with each other. In this manner, safety latch 116 is free to move between its off first position, clear of the master latch, and its on second position, interfering with or blocking master latch 100 when master latch 100 is in the latched second position.

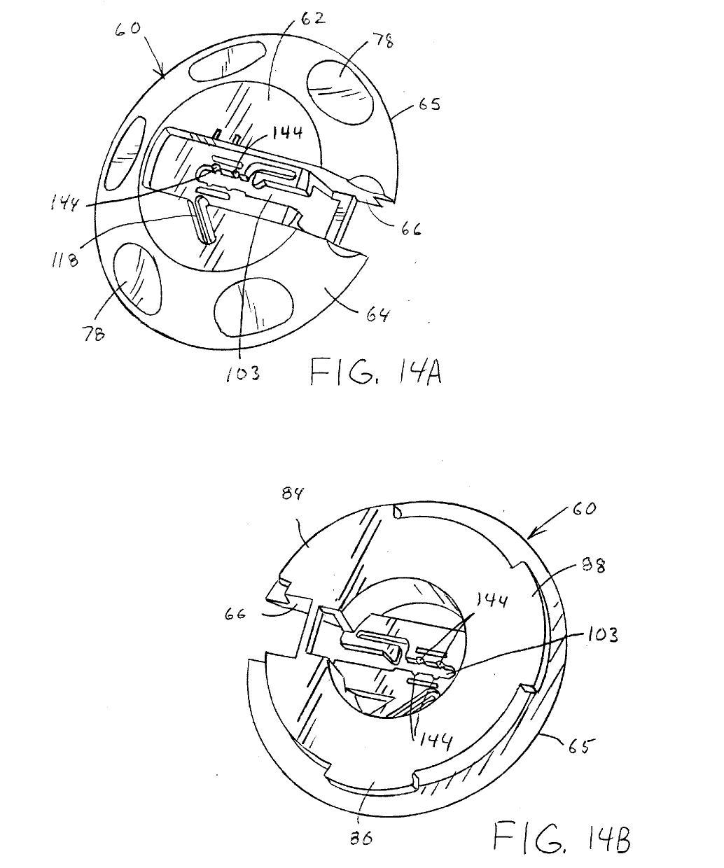

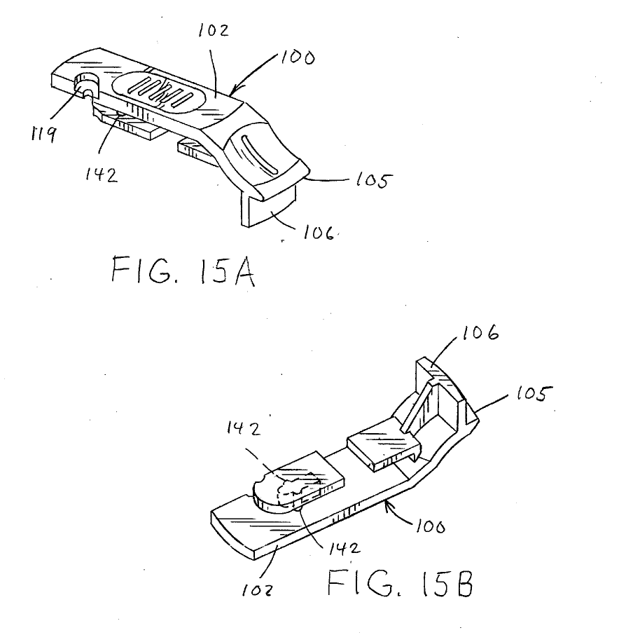

Referring now to FIGS. 14A, 14B, 15A, and 15B, in one embodiment, detents 142 are positioned on sliding body 102 such that detents 142 engage notches 144 that are positioned track 103 to retain sliding body 102 such that it resists movement from either the first position or the second position. In this manner master latch 100 is retained within the second position by detents 142. Movement of master latch 100 from the second position to the first position requires sufficient force to overcome resistance provided by detents 142. Detents 142 of sliding body 102 are configured such that movement of master latch 100 between the first and second position provides audible and tactile indications. In one embodiment, the audible indication is in the form of a clicking sound and the tactile indication is in the form of either a change in resistance, vibration, or bump. Thus, a user can be assured that master latch 100 has been successfully moved into the safe and secure second position without visually checking. In some embodiments, safety latch 116 also is configured to have detents or to receive detents such that safety latch 116 is secured in position and audible and tactile indications are provided with movement between positions.

It should be appreciated that cap 60 and its components can be made from the same materials or different materials. By way of example and not limitation, the materials of cap 60 and its components can include the following: metal, thermoplastic, polyurethane, polycarbonate, acrylonitrile butadiene styrene (ABS), polycarbonate ABS, fiberglass, fiberglass-reinforced nylon, nylon, and a combination thereof.

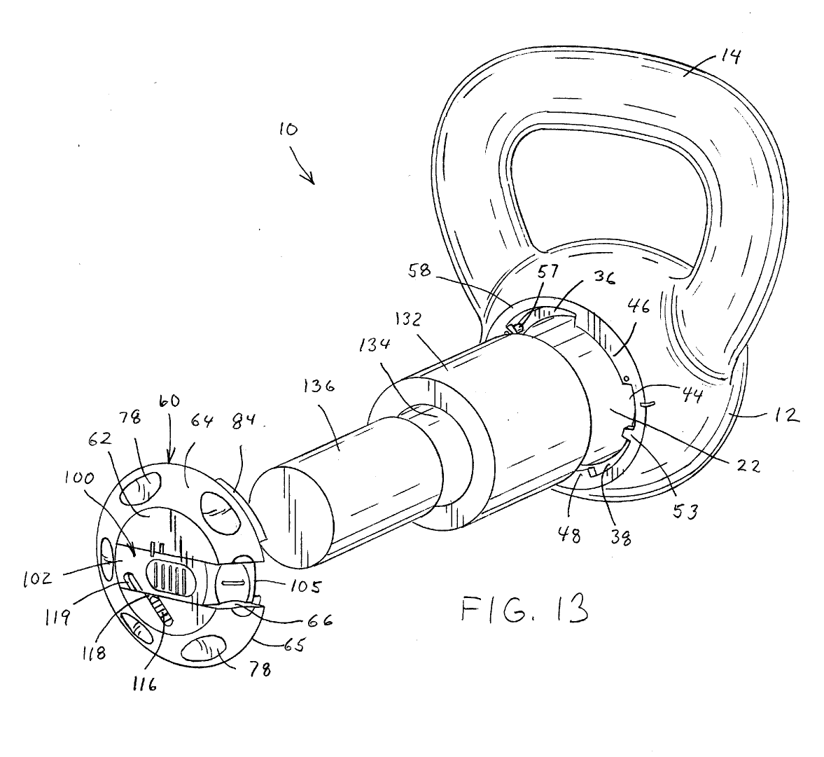

Referring now to FIGS. 4 and 13, first cavity 22 is configured to receive a generally tubular first insert 132 having a predetermined weight. First insert 132 defines a second cavity 134 therein that is dimensioned to receive a second insert 136. When cap 60 is positioned within open end of cavity 22 and in the second position such that the tabs are locked in by the ears, first cavity 22 and first insert 132 are dimensioned such that first insert 132 is substantially restrained from motion. Likewise, when cap 60 is in the closed second position, and second insert 136 is positioned within second cavity 134, both the second and first insert 132 are substantially restrained from motion.

In should be appreciated that handle 14 of kettlebell 10 and body 12 of kettlebell 10 can be made from the same materials or different materials. By way of example and not limitation, these materials can include the following: metal, cast iron, aluminum, carbon steel, stainless steel, polyurethane, polycarbonate, acrylonitrile butadiene styrene (ABS), polycarbonate ABS, fiberglass, fiberglass-reinforced nylon, nylon, and a combination thereof.

According to the illustrated embodiment, body 12, first insert 132, and second insert 136 can be combined such that kettlebell 10 can be in one of three configurations. In a first configuration, first cavity 22 is empty and kettlebell 10 has a predetermined first weight. In a second configuration, first insert 132 is within first cavity 22 and kettlebell 10 has a predetermined second weight. In a third configuration first insert 132 is within first cavity 22, and second insert 136 is within second cavity 134 and kettlebell 10 has a predetermined third weight. It should be appreciated that second insert 136 can be configured to receive a third insert which can be configured to receive a fourth insert up to N inserts. It should also be appreciated that kettlebell 10 can be used in N plus one configurations. Thus a user could use kettlebell 10 to exercise with N+1 different predetermined weights using the same body 12 and up to N inserts.

All configurations of kettlebell 10 also have substantially the same center of gravity. According to the illustrated embodiment, body 12 of kettlebell 10, first insert 132, and second insert 136 are all configured such that the center of gravity is in the same position relative to body 12 for each configuration.

The present invention can be understood in light of a description of the operation thereof. First insert 132 is placed within first cavity 22 defined within body 12. Then second insert 136 is placed within second cavity 134. It should be understood that the step of placing second insert 136 within second cavity 134 can be omitted or performed prior to the step of placing first insert 132 within first cavity 22. Cap 60 is prepared for being attached to body 12 by ensuring that safety latch 116 is in its off first position and master latch 100 is in its unlatched first position. Cap 60 is then positioned over the open end 32 of cavity 22 such that first tab 84 of cap 60 is aligned with first recess 36 of body 12, second tab 86 is aligned with second recess 38, and third tab 88 is aligned with third recess 42. After being placed in position, cap 60 is moved toward body 12 into its open and unsecure first position. In this regard, first tab 84, second tab 86, and third tab 88 are positioned such that they will pass under the associated ear of body 12. In this regard, first tab 84 is positioned to be moved to a position under first ear 46, second tab 86 is positioned to be moved under second ear 48, and third tab 88 is positioned to be moved under third ear 52. When positioned such that the tabs are in locking track 56 defined between the ears and shoulder 28, cap 60 is in the unsecure first position. Cap 60 is then rotated such that first, second, and third tabs move within locking track 56 until at least one stopping pin 57 is engaged by an adjacent ear. Contact with a stopping pin 57 ensures that first tab 84 is positioned under first ear 46, second tab 86 is positioned under second ear 48, and third tab 88 is positioned under third ear 52. In this manner, cap 60 is moved from the unsecure first position to the secure second position.

To secure cap 60 in the in the second position, master latch 100 is moved from its clear and unlatched first position to its engaged and latched second position. In such a configuration, cap 60 cannot be rotated relative to body 12 because master latch 100 tongue engages the adjacent first ear and fourth ears of body 12. To prevent master latch 100 from being moved unintentionally from the engaged second position to the clear first position, safety latch 116 is moved from its free first position to its locked second position. In this manner the inserts are retained within first cavity 22 and risk that cap 60 will be accidentally removed is essentially eliminated.

In the above manner the first and second inserts can be secured within body 12 of kettlebell 10 such that kettlebell 10 is ready for use. In order to remove cap 60 from body 12 such that the number of inserts within the cavity can be increased or decreased, the steps above are reversed. In this regard, safety latch 116 is moved from its locked second position to its free first position. Master latch 100 is moved from its engaged second position to its clear first position. Cap 60 is then rotated from the secure second position to its unsecure second position. Finally cap 60 is moved away from body 12 such that the first, second, and third tabs are no longer positioned within the race. The first and second inserts can be removed or added as appropriate.

To summarize, three deliberate steps are required to remove inserts from body 12 of kettlebell 10. Safety latch 116 must be moved, master latch 100 must be moved, and cap 60 must be rotated. Accidental contact with cap 60 will not cause cap 60 to become disengaged from body 12. Furthermore it is believed that a weight apparatus made according to the present invention can withstand a substantial amount of dropping without binding cap 60 or causing cap 60 to disengage.

While the present invention has been illustrated and described with reference to preferred embodiments thereof, it will be apparent to those skilled in the art that modifications can be made and the Invention can be practiced in other environments without departing from the spirit and scope of the invention, set forth in the accompanying claims.

Having described the invention, the following is claimed:

1. A weight apparatus, comprising:
a body that has a first cavity defined therein and the cavity extends from a closed end to an open end;
a cap configured to engage the body at the open end of the first cavity such that the first cavity is closed;
a master latch configured to be retained by the cap;
the cap being configured to rotate between an open first position and a closed second position, wherein in the open first position the cap can be separated from the body such that the first cavity is accessible and in the closed second position the cap cannot be separated from the body;
and the master latch being configured to move between an unlatched first position wherein the master latch does not interfere with rotation of the cap and a latched second position wherein the master latch does interfere with rotation of the cap.

2. The weight apparatus according to claim 1, wherein the cap includes a safety latch that is configured to move between an off first position wherein the master latch is free to move between the unlatched position and the latched position and an on second position wherein the master latch is not free to move between the unlatched position and the latched position.

3. The weight apparatus according to claim 2, wherein a first insert having a first predetermined weight is configured to be received within the first cavity and retained therein by the cap when the cap is in the closed second position.

4. The weight apparatus according to claim 3, wherein the first insert is configured to receive a second insert having a second predetermined weight such that both weights are retained within the first cavity by the cap when the cap is in the closed position.

5. The weight apparatus according to claim 1, wherein the weight apparatus has a center of gravity positioned at a first predetermined location when no inserts are positioned within the cavity.

6. The weight apparatus according to claim 5, wherein the weight apparatus has a center of gravity positioned generally at the first predetermined location when a first insert is positioned within the cavity.

7. The weight apparatus according to claim 6, wherein the weight apparatus has a center of gravity positioned generally at the first predetermined location when a second insert is positioned within the first insert.

8. A weight apparatus, comprising:
a body,
a cavity defined in the body,
a first insert,
a second insert,
a cap that is configured such that it can be engaged with the body in a manner sufficient to retain at least one of the first and second inserts within the cavity,
a master latch that is movable between a latched position and an unlatched position and the master latch is configured to retain the cap such that it is engaged with the body when the master latch is in the latched position, and
a safety latch that is configured to be movable between an off position and an on position such that when the safety latch is in the on position, the master latch is retained in the latched position.

9. The weight apparatus according to claim 8, wherein the cap includes a plurality of tabs and the body includes a plurality of ears and the tabs and the ears are configured to interact such that the cap is retained over the cavity.

10. The weight apparatus according to claim 9, where in the master latch includes a tongue that is configured to engage with adjacent ears of the body when the master latch is in the latched position such that the cap cannot be rotated relative to the body.

11. The weight apparatus according to claim 8, wherein the first insert is configured to receive the second insert therein such that both weights are retained within the cavity when the cap is engaged with the body.

12. The weight apparatus according to claim 8, wherein the weight apparatus has a center of gravity positioned at a first predetermined location when no inserts are positioned within the cavity.

13. The weight apparatus according to claim 12, wherein the weight apparatus has a center of gravity positioned generally at the first predetermined location when a first insert is positioned within the cavity.

14. The weight apparatus according to claim 13, wherein the weight apparatus has a center of gravity positioned generally at the first predetermined location when a second insert is positioned within the first insert.

15. A method for adjusting the weight of an exercise apparatus, the method comprising the steps of:
providing a body, a cavity defined in the body, a first insert, a cap that is configured such that it can be engaged with the body in a manner sufficient to retain at least one of the first and second inserts within the cavity, a master latch that is movable between a latched position and an unlatched position and the master latch is configured to retain the cap such that it is engaged with the body when the master latch is in the latched position, and a safety latch that is configured to be movable between an off position and an on position such that when the safety latch is in the on position, the master latch is retained in the latched position,
placing the first insert within the cavity
positioning the cap over the cavity
engaging the cap with the body
ensuring that the safety latch is in the off position and the master latch is in the unlatched first position
moving the master latch such that it is in the latched position, and
moving the safety latch such that it is in the on position.

16. The method for adjusting the weight of an exercise apparatus according to claim 15, further comprising the step of:
placing a second insert within the cavity,
